(19) United States
(12) Patent Application Publication
(10) Pub. No.: US 2017/0276297 A1
(43) Pub. Date: Sep. 28, 2017

(54) LED PAR LAMP AND METHOD OF MAKING

(71) Applicant: Litetronics International, Inc., Harvey, IL (US)

(72) Inventors: ROBERT SORENSEN, Harvey, IL (US); Raghu Rao, Romeoville, IL (US)

(21) Appl. No.: 15/077,876

(22) Filed: Mar. 22, 2016

(51) Int. Cl. F21K 99/00; F21V 23/00; F21V 19/00; F21V 29/89; F21V 23/06; F21V 17/06; F21V 7/04; F21V 29/70

(52) U.S. Cl. CPC F21K 9/137; F21V 7/04; F21V 23/009; F21K 9/90; F21V 29/70; F21V 29/89; F21V 23/06; F21V 17/06; F21V 19/003

(57) ABSTRACT

Technologies are described for an LED PAR lamp and of making. An LED lamp is configured to conduct heat away from an array of LEDs and to an outer surface of a housing. The LED lamp comprises a thermally conductive conical or parabolic housing having a thermally conductive film on an inner surface thereof and a thermally conductive heat accumulator is disposed on the thermally conductive film and is in conductive heat transfer communication with the housing. Each LED, in an array of LEDs, is in conductive heat transfer communication with a thermally conductive printed circuit board, the heat accumulator, and the housing.

### FIELD OF THE DISCLOSURE

This invention generally relates to lamps, and, more particularly, to an LED PAR lamp and method of making.

### BACKGROUND

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

Fluorescent light fixtures have typically been installed in a variety of applications. Typically, such fluorescent fixtures include florescent lamps with electrical connectors on each end with are connected with spaced apart lamp holders or sockets. A ballast is attached within the lamp and wiring attaches the ballast to the lamp holders. Power is supplied to the ballast by wiring brought into the light fixture. A ballast cover is used to cover the ballast and wiring. Linear, or longitudinally extending, fluorescent lamps are then placed in the lamp holders for operation of the fixture.

Since the introduction of the fluorescent lamp at the 1939 World Fair, fluorescent lighting technology has greatly advanced. For example, over the years, lamp and ballast manufacturers have developed fluorescent lamp-ballast systems with improved efficiencies. More recently, light emitting diode (LED) lamps have been developed. An LED lamp is a solid-state lamp that uses LEDs as the source of light. An LED may comprise a conventional semiconductor light emitting diode or an organic or polymeric light emitting diode. LED lamps may have one or more advantages over fluorescent lamps, for example, LED lamps do not contain mercury, they may turn on more instantaneously, they may have a longer service life, and they may have a greater efficiency.

Incandescent or halogen parabolic aluminized reflector lamps, also known as PAR lamps, emit focused light. As a result, PAR lamps are commonly used in a variety of applications, including commercial and residential. It may be desired to provide advantages of LEDs to PAR lamps.

### SUMMARY

In at least one embodiment of the present disclosure, an LED lamp is configured to conduct heat away from an array of LEDs and to an outer surface of a housing. The LED lamp comprises a thermally conductive conical or parabolic housing having a light opening and a thermally conductive film on an inner surface thereof. A base extends from an end of the housing opposite the light opening, the base is configured to hold and electrically connect the LED lamp with an electrical socket. A driver holder extends from the base and into the housing. A thermally conductive heat accumulator is disposed on the thermally conductive film and is in conductive heat transfer communication with the housing. A bottom wall extends inwardly from an axial end of the heat accumulator, the axial end being proximate the base. A thermally conductive printed circuit board is on the bottom wall of the heat accumulator. A driver is disposed in the driver holder and is in electrical communication with the thermally conductive printed circuit board and the base. An array of LEDs are disposed on the thermally conductive printed circuit board and are in electrical communication with the driver. Each LED, in the array of LEDs, is in conductive heat transfer communication with the thermally conductive printed circuit board, the heat accumulator, and the housing.

In at least one other embodiment of the present disclosure, a method of making an LED lamp is provided. The method comprises providing a thermally conductive conical or parabolic housing having a light opening in a first axial end, a base opening in a second axial end, and a thermally conductive film on an inner surface thereof. A base is placed about the base opening in the housing and a first end of a driver holder is screwed into the base, wherein a second end of the driver holder extends into the housing. An outer wall of a thermally conductive heat accumulator is fastened onto the thermally conductive film and a bottom wall of the heat accumulator is fastened onto the second end of the driver holder. The thermally conductive heat accumulator becomes in conductive heat transfer communication with the housing. A thermally conductive printed circuit board is fastened on the bottom wall of the heat accumulator.

### BRIEF DESCRIPTIONS OF THE DRAWINGS

The following figures, which are idealized, are not to scale and are intended to be merely illustrative of aspects of the present disclosure and non-limiting. In the drawings, like elements are depicted by like reference numerals. The drawings are briefly described as follows.

FIG. 1 is a perspective view of an LED PAR lamp of the present disclosure;

FIG. 2 is an exploded view of the LED PAR lamp shown in FIG. 1;

FIG. 3 is a perspective view of the LED PAR lamp housing of the present disclosure;

FIG. 4 is a top view of the thermally conductive heat accumulator of the present disclosure;

FIG. 5 is a view of a driver and driver holder of the present disclosure;

FIG. 6 is a view of an array of LEDs disposed on a thermally conductive printed circuit board of the present disclosure; and

FIG. 7 is a break-away view of the LED PAR lamp shown in FIG. 1.

### DETAILED DESCRIPTION

Reference will now be made in detail to the present exemplary embodiments and aspects of the present invention, examples of which are illustrated in the accompanying figures. The same reference numbers may be used in the figures to refer to the same or like parts. The presently disclosed embodiments, aspects, and features of the present invention are not to limit the presently claimed invention as other and different embodiments, aspects, and features will become apparent to one skilled in the art upon reading the present disclosure.

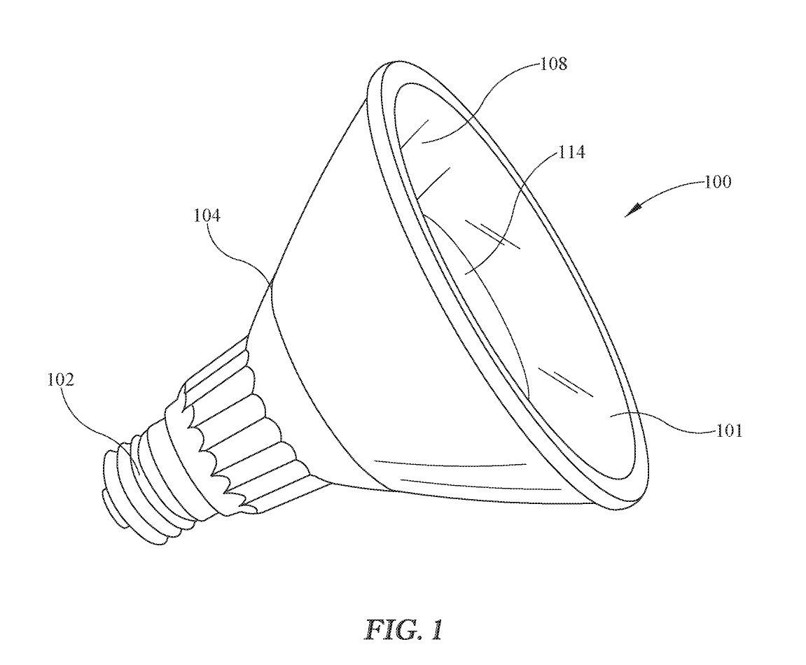

FIG. 1 shows a perspective view of LED PAR lamp 100 of the present disclosure. LED PAR lamp 100 is configured to conduct heat away from an array of LEDs and to an outer surface of a housing 104. Housing 104 is thermally conductive and has a conical or parabolic configuration with a light opening 101. Base 102 extends from an end of thermally conductive housing 104 opposite light opening 101. Base 102 is configured to hold and electrically connect LED PAR lamp 100 with an electrical socket. For example, base 102 may be cylindrical and comprise a helical thread 103 on an outer surface configured to threadingly engage, or screw into, a traditional lamp socket.

A thermally conductive heat accumulator 108 is disposed on a thermally conductive film on an inner surface of LED PAR lamp 100. Thermally conductive heat accumulator 108 has a conical or parabolic outer wall, entirely, or substantially entirely, in conductive heat transfer communication with an inner surface of thermally conductive housing 104. Reflection cup 114 may be disposed about an array of LEDs and be configured to direct light toward light opening 101.

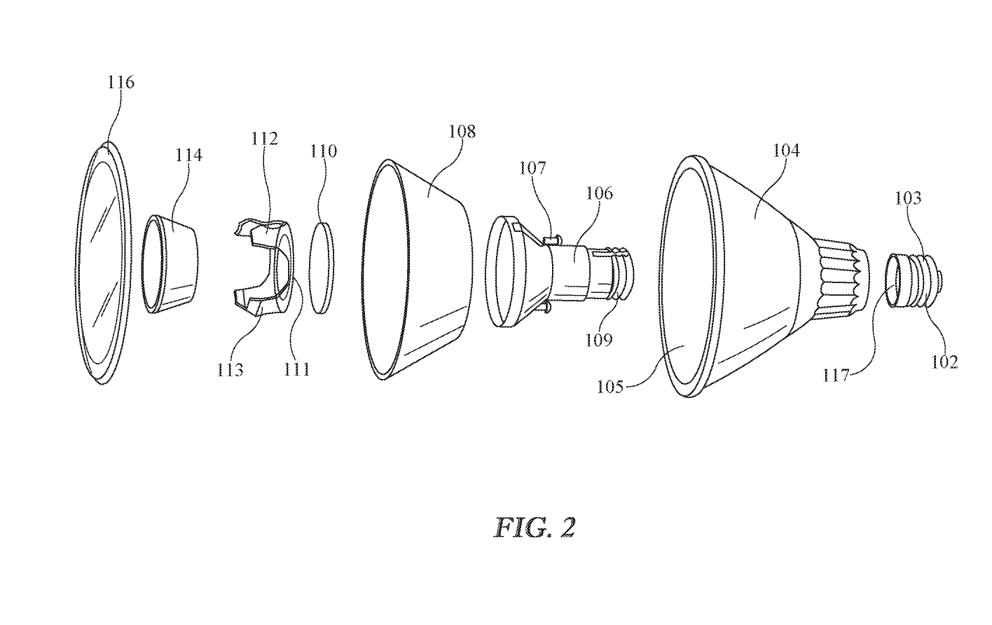

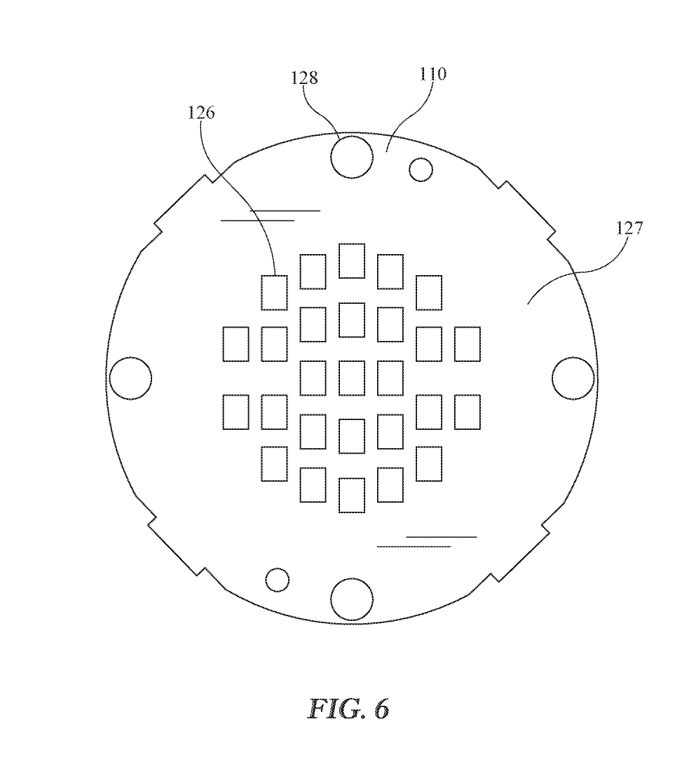

FIG. 2 is an exploded view of LED PAR lamp 100 showing cooperation of component parts thereof. LED PAR lamp 100 is configured to conduct heat away from an array of LEDs 126, shown in FIG. 6, and to an outer surface of thermally conductive housing 104. Thus, LED PAR lamp 100 may maximize conductive heat transfer from the array of LEDs and maximize convective heat transfer from LED PAR lamp 100.

Thermally conductive housing 104 has a conical or parabolic configuration, or PAR configuration, with a light opening 101 and a thermally conductive film 105 on an inner surface thereof. Base 102 is configured to extend from an end of thermally conductive housing 104, opposite light opening 101, and to hold and electrically connect LED PAR lamp 100 with an electrical socket.

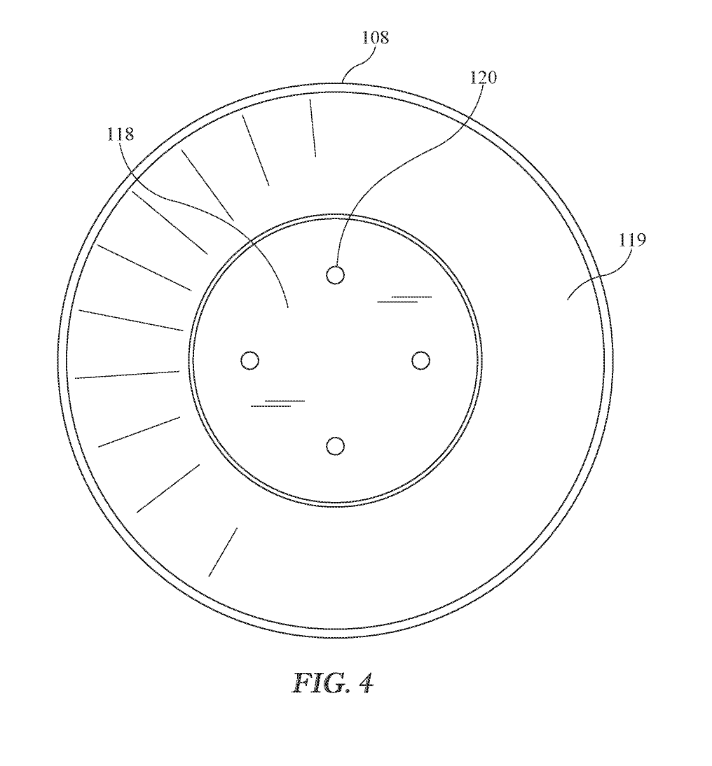

Driver holder 106 is configured to extend from base 102 and into thermally conductive housing 104. Thermally conductive heat accumulator 108 is configured to be disposed on the thermally conductive film 105 and in conductive heat transfer communication with thermally conductive housing 104. For example, thermally conductive heat accumulator 108 may have a conical or parabolic outer wall 119, shown in FIG. 4, configured to be entirely, or substantially entirely, in conductive heat transfer communication with an inner surface of thermally conductive housing 104 or thermally conductive film 105.

Thermally conductive heat accumulator 108 may have a bottom wall 118, shown in FIG. 4, extending inwardly from outer wall 119. Bottom wall 118 may be configured to become fastened to driver holder 106. Thermally conductive printed circuit board 110 may be configured to be fastened to bottom wall 118 of heat accumulator 108. In the assembled configuration of LED PAR lamp 100, as shown in FIG. 1, heat produced with LEDs on printed circuit board 110 is conducted through circuit board 110, heat accumulator 108, thermally conductive film 105, and to an outer surface of thermally conductive housing 104.

LED PAR lamp 100 may have a reflection cup 114 disposed with printed circuit board 110. Reflection cup 114 has a reflective inner surface configured to reflect a portion of light to be emitted, from an array of LEDs on printed circuit board 110, to light opening 101. For example, reflection cup 114 may have a frustoconical configuration and may have its smaller diameter opening on, or proximate, thermally conductive printed circuit board 110. A reflection cup holder 112 may extend from thermally conductive printed circuit board 110 and hold reflection cup 114. In an illustration of reflection cup holder 112, reflection cup holder 112 has a base 111 configured to be mounted onto thermally conductive printed circuit board 110, around an array of LEDs. Prongs 113 may extend from base 111 and be configured to hold reflection cup 114, about its larger diameter frustoconical opening.

LED PAR lamp 100 may have a light transmissive cover 116 configured to be disposed over light opening 101. For example, a lens, or other cover, may be placed about an outer perimeter of light opening 101 or within heat accumulator 108. Light transmissive cover 116 may be configured to scatter, soften, or direct the light emitted from LED PAR lamp 100.

Base 102 may have a helical thread 117 on an inner surface thereof. In an illustrative example, base 102 has a cylindrical wall contoured to have both inner helical thread 117 and outer helical thread 103. Driver holder 106 may have an outer helical threaded portion 109 configured to threadingly engage inner helical thread 117, on base 102.

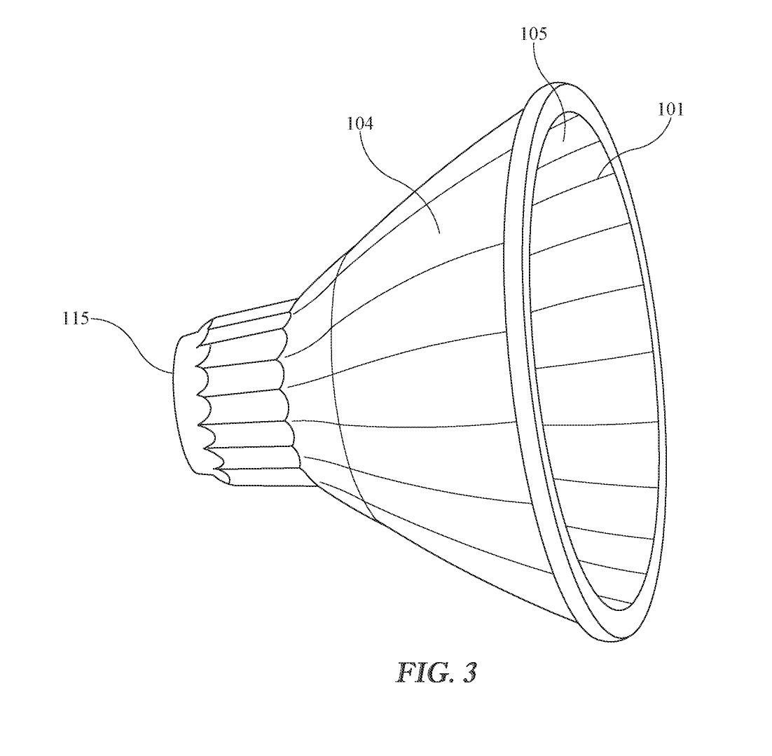

FIG. 3 shows a perspective view of the LED PAR lamp housing 104. LED PAR lamp housing 104 is conical or parabolic and thermally conductive. In at least one illustrative example, LED PAR lamp housing 104 is comprised of glass. A thermally conductive film 105 may be disposed on an inner surface of LED PAR lamp housing 104. In at least one illustrative example, thermally conductive film 105 is metallic. For example, thermally conductive film 105 may be an anodized inner surface of LED PAR lamp housing 104. In at least illustrative example, thermally conductive film 105 is at least on an area of the inner surface LED PAR lamp housing 104 configured to hold heat accumulator 108.

FIG. 4 shows a top view of the thermally conductive heat accumulator 108. Thermally conductive heat accumulator 108 may be comprised of a metallic material. Thermally conductive heat accumulator 108 may have an outer conical or parabolic outer wall 119 configured to mate with thermally conductive film 105, on the inner conical or parabolic wall portion of housing 104. Extending inward from the lesser diameter edge of outer wall 119 is bottom wall 118. Bottom wall 118 may be planar and may be configured to attach with driver housing 106. For example, bottom wall 118 may have apertures 120 configured to receive a fastener for fastening to driver holder 106, and/or for receiving wires extending from driver 122.

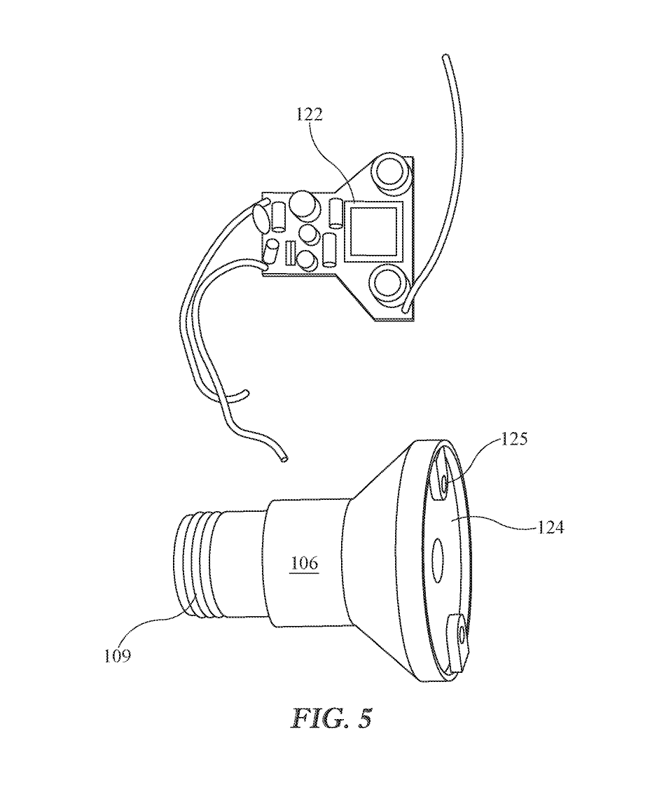

FIG. 5 shows driver 122 and driver holder 106. Driver holder 106 may be configured to hold driver 122 therein and have driver wires electrically communicating with base 102 and printed circuit board 110. Driver holder 106 may be potted with potting material 124. Driver holder 106 may have apertures 125 proximate an outer perimeter configured for fastening with heat accumulator 108, printed circuit board 110, and optionally, reflection cup holder 112. In at least one illustrative example, driver holder 106 has apertures 125, heat accumulator 108 has apertures 120, and thermally conductive printed circuit board 110 has apertures 128 axially aligned to receive a fastener 107. Base 111 of optional reflection cup holder 112 may also have apertures axially aligned to receive fastener 107.

FIG. 6 shows an array of LEDs 126 disposed on a thermally conductive printed circuit board 110. Thermally conductive printed circuit board 110 provides electrical communication between driver 122 and each LED in the array of LEDs 126. Thermally conductive printed circuit board 110 may have a planar and circular wall 127 configured to fasten to bottom wall 118, of heat accumulator 108. In an illustrative example, thermally conductive printed circuit board 110 is configured to have substantially an entire surface of wall 127, the surface opposite the array of LEDs 126, in conductive heat transfer communication with bottom wall 118. The array of LEDs 126 may be on a central portion of thermally conductive printed circuit board 110 and apertures 128 may be proximate an outer perimeter of thermally conductive printed circuit board 110. Apertures 128 may be configured to receive fasteners 107 or wires extending from drivers 122.

In an illustrative example, each LED, in the array of LEDs 126, is in conductive heat transfer communication with thermally conductive printed circuit board 110, heat accumulator 108, and housing 104.

In at least one illustrative example of LED PAR lamp 100, driver holder 106 has apertures 125, bottom wall 118 of heat accumulator 108 has apertures 120, and the thermally conductive printed circuit board has apertures 128, wherein at least one of each aperture, 128, 120, and 128, are aligned to receive a fastener 107 therethrough and hold driver holder 106, heat accumulator 108, and thermally conductive printed circuit board 110 together in conductive heat transfer communication with each other.

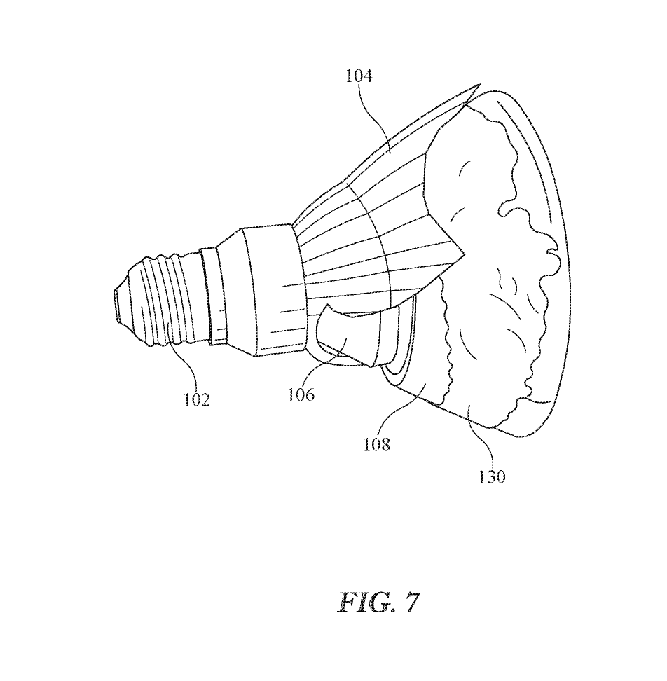

FIG. 7 shows a break-away view of LED PAR lamp 100. LED PAR lamp 100 may have a thermally conductive adhesive 130 disposed between heat accumulator 108 and housing 104, holding heat accumulator 108 in conductive heat transfer communication with the thermally conductive film 105. Thermally conductive adhesive 130 may comprises at least one of epoxy, cyanoacrylate, metals, metal oxides, and microspheres of silica or ceramic.

A method of making an LED lamp the LED PAR lamp of the present disclosure is presently provided. The method comprises providing a thermally conductive conical or parabolic housing having a light opening in a first axial end, a base opening in a second axial end, and a thermally conductive film on an inner surface thereof. A base is placed base about the base opening in the second axial end of the housing. A first end of a driver holder is screwed into the base, wherein a second end of the driver holder extends into the housing. A thermally conductive heat accumulator is fastened onto the thermally conductive film and a bottom wall of the thermally conductive heat accumulator is fastened onto the second end of the driver holder. The thermally conductive heat accumulator becomes in conductive heat transfer communication with the housing. A thermally conductive printed circuit board is fastened onto the bottom wall of the heat accumulator.

The method may comprise a step of adhering, with thermally conductive adhesive, the outer wall of the thermally conductive heat accumulator onto the thermally conductive film. A reflection cup may be fastened onto the thermally conductive printed circuit board. The fastening of a bottom wall of the thermally conductive heat accumulator onto the second end of the driver holder; the fastening of a thermally conductive printed circuit board on the bottom wall of the heat accumulator; and the fastening of a reflection cup onto the thermally conductive printed circuit board may be performed by inserting a fastener through an aperture in the driver holder, an aperture in the bottom wall of the heat accumulator, an aperture in the thermally conductive printed circuit board, and an aperture in a reflection cup holder, and fastened. A light transmissive cover may be fastened about the light opening in the housing and the driver holder may be potted.

There is thus provided an LED PAR lamp and method making. One feature or aspect of an illustrative example is believed at the time of the filing of this patent application to possibly reside broadly in an LED lamp configured to conduct heat away from an array of LEDs and to an outer surface of a housing. The LED lamp comprises a thermally conductive conical or parabolic housing having a light opening and a thermally conductive film on an inner surface thereof. A base extends from an end of the housing opposite the light opening, the base is configured to hold and electrically connect the LED lamp with an electrical socket. A driver holder extends from the base and into the housing. A thermally conductive heat accumulator is disposed on the thermally conductive film and is in conductive heat transfer communication with the housing. A bottom wall extends inwardly from an axial end of the heat accumulator, the axial end being proximate the base. A thermally conductive printed circuit board is on the bottom wall of the heat accumulator. A driver is disposed in the driver holder and is in electrical communication with the thermally conductive printed circuit board and the base. An array of LEDs are disposed on the thermally conductive printed circuit board and are in electrical communication with the driver. Each LED, in the array of LEDs, is in conductive heat transfer communication with the thermally conductive printed circuit board, the heat accumulator, and the housing.

Another feature or aspect of an illustrative example is believed at the time of the filing of this patent application to possibly reside broadly in an LED PAR lamp comprising a thermally conductive adhesive disposed between the heat accumulator and the housing, holding the heat accumulator in conductive heat transfer communication with the thermally conductive film.

Yet another feature or aspect of an illustrative example is believed at the time of the filing of this patent application to possibly reside broadly in an LED PAR lamp wherein the thermally conductive adhesive comprises at least one of epoxy and cyanoacrylate.

Still another feature or aspect of an illustrative example is believed at the time of the filing of this patent application to possibly reside broadly in an LED PAR lamp wherein the thermally conductive adhesive comprises at least one of metals, metal oxides, and microspheres of silica or ceramic.

A further feature or aspect of an illustrative example is believed at the time of the filing of this patent application to possibly reside broadly in an LED PAR lamp comprising a reflection cup disposed with the printed circuit board, the reflection cup being configured to reflect a portion of light to be emitted from the array of LEDs to the light opening.

Another feature or aspect of an illustrative example is believed at the time of the filing of this patent application to possibly reside broadly in an LED PAR lamp comprising reflection cup holder extending from the thermally conductive printed circuit board and holding the reflection cup.

Yet another feature or aspect of an illustrative example is believed at the time of the filing of this patent application to possibly reside broadly in an LED PAR lamp wherein the reflection cup holder has a base mounted on the thermally conductive printed circuit board and around the array of LEDs and at least two prongs extending from the base, the at least two prongs holding the reflection cup.

Still another feature or aspect of an illustrative example is believed at the time of the filing of this patent application to possibly reside broadly in an LED PAR lamp comprising a light transmissive cover disposed over the light opening.

A further feature or aspect of an illustrative example is believed at the time of the filing of this patent application to possibly reside broadly in an LED PAR lamp wherein the base is cylindrical and comprises a helical thread on an outer surface configured to threadingly engage the electrical socket.

Another feature or aspect of an illustrative example is believed at the time of the filing of this patent application to possibly reside broadly in an LED PAR lamp wherein the base further comprises a helical thread on an inner surface threadingly engaging an outer helical thread on the driver holder.

Yet another feature or aspect of an illustrative example is believed at the time of the filing of this patent application to possibly reside broadly in an LED PAR lamp wherein the driver holder is potted.

One feature or aspect of an illustrative example is believed at the time of the filing of this patent application to possibly reside broadly in an LED PAR lamp wherein the thermally conductive housing is glass.

Another feature or aspect of an illustrative example is believed at the time of the filing of this patent application to possibly reside broadly in an LED PAR lamp wherein the thermally conductive film is metallic.

Yet another feature or aspect of an illustrative example is believed at the time of the filing of this patent application to possibly reside broadly in an LED PAR lamp wherein the driver holder, the bottom wall of the heat accumulator, and the thermally conductive printed circuit board each have at least one aperture receiving a fastener therethrough and holding the driver holder, the heat accumulator, and the thermally conductive printed circuit board together in conductive heat transfer communication with each other.

Still another feature or aspect of an illustrative example is believed at the time of the filing of this patent application to possibly reside broadly in a method of making an LED lamp comprising providing a thermally conductive conical or parabolic housing having a light opening in a first axial end, a base opening in a second axial end, and a thermally conductive film on an inner surface thereof; placing a base about the base opening in the housing; screwing a first end of a driver holder into the base, wherein a second end of the driver holder extends into the housing; fastening an outer wall of a thermally conductive heat accumulator onto the thermally conductive film and a bottom wall onto the second end of the driver holder, wherein the thermally conductive heat accumulator is in conductive heat transfer communication with the housing; and fastening a thermally conductive printed circuit board on the bottom wall of the heat accumulator.

A further feature or aspect of an illustrative example is believed at the time of the filing of this patent application to possibly reside broadly in a method of making an LED lamp comprising a step of adhering, with thermally conductive adhesive, the outer wall of the thermally conductive heat accumulator onto the thermally conductive film.

Another feature or aspect of an illustrative example is believed at the time of the filing of this patent application to possibly reside broadly in a method of making an LED lamp comprising a step of fastening a reflection cup onto the thermally conductive printed circuit board.

Yet another feature or aspect of an illustrative example is believed at the time of the filing of this patent application to possibly reside broadly in a method of making an LED lamp wherein the steps of fastening a bottom wall of the thermally conductive heat accumulator onto the second end of the driver holder, fastening a thermally conductive printed circuit board on the bottom wall of the heat accumulator, and fastening a reflection cup onto the thermally conductive printed circuit board are performed by inserting a fastener through an aperture in the driver holder, an aperture in the bottom wall of the heat accumulator, an aperture in the thermally conductive printed circuit board, and an aperture in a reflection cup holder, and fastening.

Still another feature or aspect of an illustrative example is believed at the time of the filing of this patent application to possibly reside broadly in a method of making an LED lamp comprising a step of fastening a light transmissive cover about the light opening in the housing.

A further feature or aspect of an illustrative example is believed at the time of the filing of this patent application to possibly reside broadly in a method of making an LED lamp comprising a step of potting the driver holder.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g.,“a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g.,“a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### NOMENCLATURE

LED PAR lamp 100
light opening 101
base 102
helical thread 103
housing 104
thermally conductive film 105
Driver holder 106
fastener 107
Thermally conductive heat accumulator 108
driver holder outer helical threaded portion 109
Thermally conductive printed circuit board 110
reflection cup holder base 111
reflection cup holder 112
reflection cup holder prongs 113
reflection cup 114
base opening 115
light transmissive cover 116
base inner helical thread 117
heat accumulator bottom wall 118
heat accumulator outer wall 119
apertures 120
driver 122
potting material 124
apertures 125
array of LEDs 126
thermally conductive printed circuit board wall 127
apertures 128
thermally conductive adhesive 130

1. An LED lamp configured to conduct heat away from an array of LEDs and to an outer surface of a housing, the LED lamp comprising:
a thermally conductive conical or parabolic housing having a light opening and a thermally conductive film on an inner surface thereof;
a base extending from an end of the housing opposite the light opening, the base being configured to hold and electrically connect the LED lamp with an electrical socket;
a driver holder extending from the base and into the housing;
a thermally conductive heat accumulator disposed on the thermally conductive film and in conductive heat transfer communication with the housing;
a bottom wall extending inwardly from an axial end of the heat accumulator, the axial end being proximate the base;
a thermally conductive printed circuit board on the bottom wall of the heat accumulator;
a driver disposed in the driver holder and in electrical communication with the thermally conductive printed circuit board and the base;
an array of LEDs disposed on the thermally conductive printed circuit board and in electrical communication with the driver;
wherein each LED, in the array of LEDs, is in conductive heat transfer communication with the thermally conductive printed circuit board, the heat accumulator, and the housing.

2. The LED lamp of claim 1 further comprising a thermally conductive adhesive disposed between the heat accumulator and the housing, holding the heat accumulator in conductive heat transfer communication with the thermally conductive film.

3. The LED lamp of claim 2, wherein the thermally conductive adhesive comprises at least one of epoxy and cyanoacrylate.

4. The LED lamp of claim 2, wherein the thermally conductive adhesive comprises at least one of metals, metal oxides, and microspheres of silica or ceramic.

5. The LED lamp of claim 1 further comprising a reflection cup disposed with the printed circuit board, the reflection cup being configured to reflect a portion of light to be emitted from the array of LEDs to the light opening.

6. The LED lamp of claim 5 further comprising reflection cup holder extending from the thermally conductive printed circuit board and holding the reflection cup.

7. The LED lamp of claim 6, wherein the reflection cup holder has a base mounted on the thermally conductive printed circuit board and around the array of LEDs and at least two prongs extending from the base, the at least two prongs holding the reflection cup.

8. The LED lamp of claim 1 further comprising a light transmissive cover disposed over the light opening.

9. The LED lamp of claim 1, wherein the base is cylindrical and comprises a helical thread on an outer surface configured to threadingly engage the electrical socket.

10. The LED lamp of claim 9, wherein the base further comprises a helical thread on an inner surface threadingly engaging an outer helical thread on the driver holder.

11. The LED lamp of claim 1, wherein the driver holder is potted.

12. The LED lamp of claim 1, wherein the thermally conductive housing is glass.

13. The LED lamp of claim 1, wherein the thermally conductive film is metallic.

14. The LED lamp of claim 1, wherein the driver holder, the bottom wall of the heat accumulator, and the thermally conductive printed circuit board each have at least one aperture receiving a fastener therethrough and holding the driver holder, the heat accumulator, and the thermally conductive printed circuit board together in conductive heat transfer communication with each other.

15. A method of making an LED lamp comprising the steps of:
providing a thermally conductive conical or parabolic housing having a light opening in a first axial end, a base opening in a second axial end, and a thermally conductive film on an inner surface thereof;
placing a base about the base opening in the housing;
screwing a first end of a driver holder into the base, wherein a second end of the driver holder extends into the housing;
fastening an outer wall of a thermally conductive heat accumulator onto the thermally conductive film and a bottom wall onto the second end of the driver holder, wherein the thermally conductive heat accumulator is in conductive heat transfer communication with the housing; and
fastening a thermally conductive printed circuit board on the bottom wall of the heat accumulator.

16. The method of making an LED lamp of claim 15, further comprising a step of adhering, with thermally conductive adhesive, the outer wall of the thermally conductive heat accumulator onto the thermally conductive film.

17. The method of making an LED lamp of claim 15, further comprising a step of fastening a reflection cup onto the thermally conductive printed circuit board.

18. The method of making an LED lamp of claim 17, wherein the steps of fastening a bottom wall of the thermally conductive heat accumulator onto the second end of the driver holder, fastening a thermally conductive printed circuit board on the bottom wall of the heat accumulator, and fastening a reflection cup onto the thermally conductive printed circuit board are performed by inserting a fastener through an aperture in the driver holder, an aperture in the bottom wall of the heat accumulator, an aperture in the thermally conductive printed circuit board, and an aperture in a reflection cup holder, and fastening.

19. The method of making an LED lamp of claim 15, further comprising a step of fastening a light transmissive cover about the light opening in the housing.

20. The method of making an LED lamp of claim 15, further comprising a step of potting the driver holder.
